(19) United States
(12) Patent Application Publication
(10) Pub. No.: US 2024/0420084 A1
(43) Pub. Date: Dec. 19, 2024

(54) LIVE SHARING OF VIRTUAL COLLABORATION IN SOCIAL NETWORKS

(71) Applicant: International Business Machines Corporation, Armonk, NY (US)

(72) Inventors: Sarbajit K. Rakshit, Kolkata (IN); Mallanagouda B Patil, Bangalore (IN); Shailendra Moyal, Pune (IN)

(21) Appl. No.: 18/333,716

(22) Filed: Jun. 13, 2023

(51) Int. Cl. G06Q 10/10; G06Q 50/00

(52) U.S. Cl. CPC G06Q 10/103; G06Q 50/01

(57) ABSTRACT

Techniques are described with respect to a system, method, and computer product for a method for sharing virtual environment collaboration. An associated method includes analyzing a virtual environment and determining a plurality of contextual information and a degree of shareability associated with the virtual environment based on the analysis. The method further including presenting the virtual environment to a social media network associated with a user based on the degree of shareability.

### FIELD

This disclosure relates generally to virtual reality and augmented reality, and more particularly to computing systems, computer-implemented methods, and computer program products configured to provide live sharing of virtual collaboration within social networks.

Social media networks and sites have become one of the most universally popular mechanisms for communication and disseminating information. For example, users may utilize live streaming functionalities in order to share live content amongst social media network audiences and receive real-time feedback from viewers. However, the aforementioned functionalities may be performed in a public manner creating privacy, security, and safety risks not only for the content uploaders, but also the viewers and commentors due to the accessibility to the general public. For example, location sharing done by a live-streamer may pose an immediate risk to the live-streamer and their surrounding environment.

In addition, social media networks may be utilized as platforms for hosting virtual collaborations in which users across geographic locations meet in a virtual centralized location to communicate and exchange content; however, these virtual locations may also run into privacy, security, and safety issues due to public accessibility in addition to suffer from limitations that arise from a context of the virtual collaboration not being established.

### SUMMARY

Additional aspects and/or advantages will be set forth in part in the description which follows and, in part, will be apparent from the description, or may be learned by practice of the invention.

Embodiments relate to a method, system, and computer program product for sharing virtual environment collaboration. In some embodiments, the computer-implemented method for sharing virtual environment collaboration comprises analyzing a virtual environment; determining a plurality of contextual information and a degree of shareability associated with the virtual environment based on the analysis; and presenting the virtual environment to a social media network associated with a user based on the degree of shareability.

### BRIEF DESCRIPTION OF THE DRAWINGS

These and other objects, features, and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates a networked computer environment, according to an exemplary embodiment;

FIG. 2 illustrates a virtual collaboration for social media system environment, according to an exemplary embodiment;

FIG. 3 illustrates a block diagram of various modules associated with the virtual collaboration for social media system of FIG. 2, according to an exemplary embodiment;

FIG. 4 illustrates a virtual environment associated with a social network processed by the system of FIG. 1, according to an exemplary embodiment; and

FIG. 5 illustrates an exemplary flowchart depicting a method for sharing virtual environment collaboration, according to an exemplary embodiment.

### DETAILED DESCRIPTION

Detailed embodiments of the claimed structures and methods are disclosed herein; however, it can be understood that the disclosed embodiments are merely illustrative of the claimed structures and methods that may be embodied in various forms. Those structures and methods may, however, be embodied in many different forms and should not be construed as limited to the exemplary embodiments set forth herein. Rather, these exemplary embodiments are provided so that this disclosure will be thorough and complete and will fully convey the scope to those skilled in the art. In the description, details of well-known features and techniques may be omitted to avoid unnecessarily obscuring the presented embodiments.

The terms and words used in the following description and claims are not limited to the bibliographical meanings, but are merely used to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

It should be understood that the Figures are merely schematic and are not drawn to scale. It should also be understood that the same reference numerals are used throughout the Figures to indicate the same or similar parts.

In the context of the present application, where embodiments of the present invention constitute a method, it should be understood that such a method is a process for execution by a computer, i.e., is a computer-implementable method. The various steps of the method therefore reflect various parts of a computer program, e.g., various parts of one or more algorithms.

Also, in the context of the present application, a system may be a single device or a collection of distributed devices that are adapted to execute one or more embodiments of the methods of the present invention. For instance, a system may be a personal computer (PC), a server or a collection of PCs and/or servers connected via a network such as a local area network, the Internet and so on to cooperatively execute at least one embodiment of the methods of the present invention.

As used herein, the term “virtual collaboration” includes any mechanism for hosting digital sessions carried out via technology-mediated communications which may include, but are not limited to, live broadcasting services, online video sharing/hosting, gaming platform services, social media platform content (e.g., forums, posts, streaming sessions, etc.), virtual matchmaking services, videotelephony/video-conferencing, augmentative and alternative communication (AAC), voice over internet protocol (VOIP), metaverses, and other applicable form of telecommunications known to those of ordinary skill in the art.

The following described exemplary embodiments provide a method, computer system, and computer program product for sharing virtual environment collaboration. Social networking systems have become one of the most popular forms for steadily and smoothly streaming media content and facilitating interactions among persons and organizations. Social network systems have further become mechanisms to connect and share information across users, in which social network systems have the potential to transform countless aspects of communication within human life. For example, social networking has started to be integrated into virtual, augmented, mixed, and/or extended reality environments allowing users to interact and communicate among each other in real-time with generated images, sounds, haptic feedback, and other sensations to augment a real world environment. However, this combination of technology exposes users to privacy concerns regarding virtual collaboration environments involving confidential and/or sensitive subject matter or more intimate virtual settings. Therefore, the present embodiments have the capacity to improve the technical fields of virtual/augmented reality and social networking by not only generating privatized virtual environments for presentation and collaboration within social networks, but also modifying virtual environment privacy settings based on the determined context of the virtual environment and/or the users present.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

It is further understood that although this disclosure includes a detailed description on cloud-computing, implementation of the teachings recited herein are not limited to a cloud-computing environment. Rather, embodiments of the present invention are capable of being implemented in conjunction with any other type of computing environment now known or later developed.

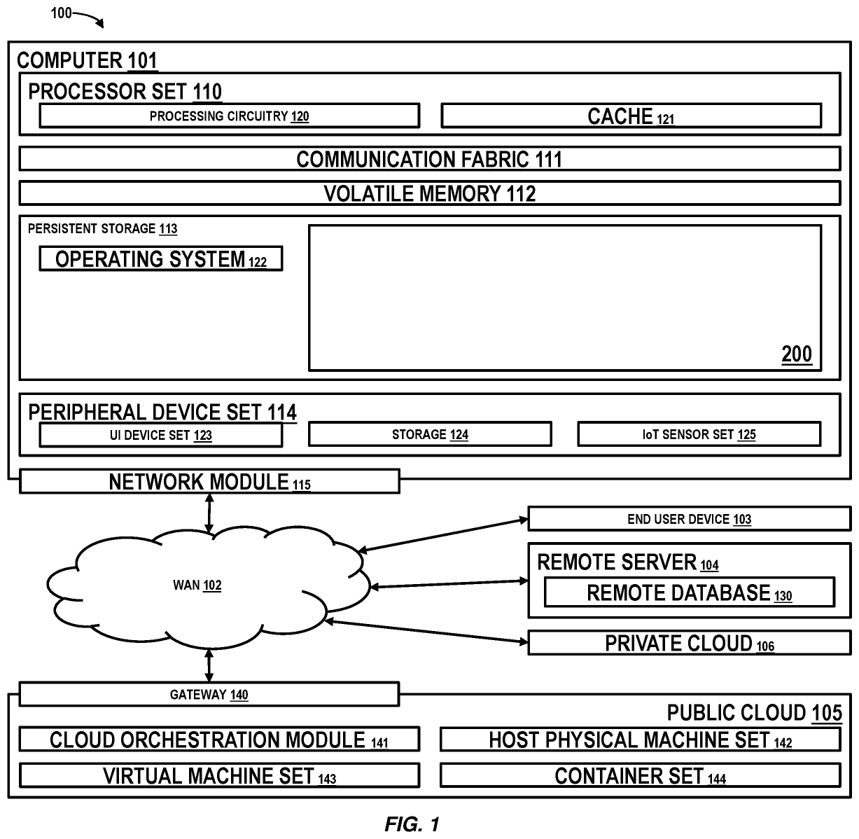

The following described exemplary embodiments provide a system, method and computer program product for sharing virtual environment collaboration. Referring now to FIG. 1, a computing environment 100 contains an example of an environment for the execution of at least some of the computer code involved in performing the inventive methods, such as system 200. In addition to system 200, computing environment 100 contains an example of an environment for the execution of at least some of the computer code involved in performing the inventive methods. Computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and system 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, computer-mediated reality device (e.g., AR/VR headsets, AR/VR goggles, AR/VR glasses, etc.), mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) payment device), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD payment device. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter payment device or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

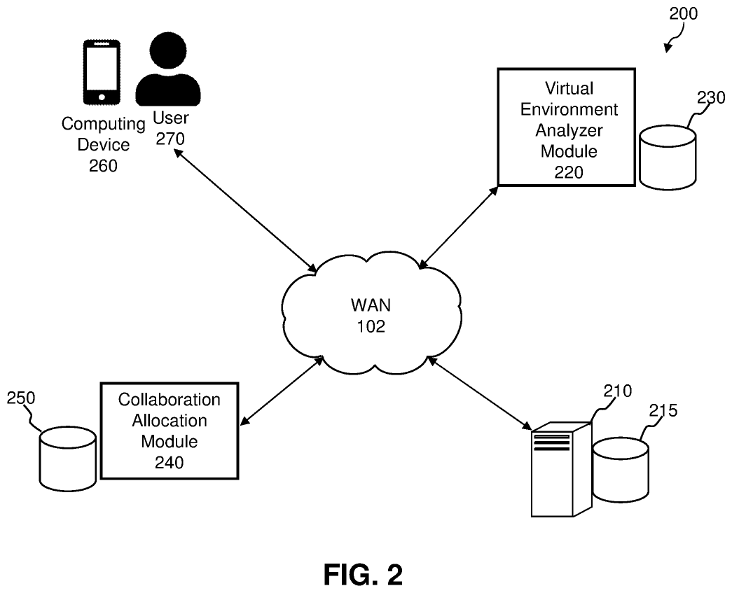

Referring now to FIG. 2, a functional block diagram of a networked computer environment illustrating a computing environment for an augmented reality experience merging environment system 200 (hereinafter “system”) comprising a server 210 communicatively coupled to a database 215, an virtual environment analyzer module 220 communicatively coupled to a virtual environment analyzer module database 230, a collaboration allocation module 240 communicatively coupled to a collaboration allocation module database 250, and a computing device 260 associated with a user 270, each of which are communicatively coupled over WAN 102 (hereinafter “network”) and data from the components of system 200 transmitted across the network is stored in database 215.

In some embodiments, server 210 is configured to operate a centralized platform serving as a cloud-based virtual environment analyzer and privacy allocating platform for social networks within virtual/augmented reality environments. Server 210 is configured to provide a mechanism of user 270 to establish preferences, privacy settings, and the like via accessing one or more user interfaces and application programming interfaces (APIs) provided to computing device 260. Traditionally, social media content (e.g., live-stream media, posts, shares, etc.) may be published by social media users in which they are viewed within the virtual environment hosted by a VR/AR service providing platform; however, the centralized platform is configured to allow user 270 to view virtual collaborations within the virtual environment associated with the applicable social network based on a plurality of privacy rights assigned to the social media content and/or the virtual environment by collaboration allocation module 240. The centralized platform further allows user 270 to make adjustments to the privacy rights based upon preferences and/or the context of the social media content/virtual environment. For example, the virtual collaboration may be a multi-party discussion (i.e., telecommunication meeting) pertaining to sensitive subject matter, in which user 270 may access the centralized platform in order to determine not only who has access to the virtual collaboration presented via the social network, but also the role of the individuals within the virtual environment.

In some embodiments, server 210 is associated with one or more web crawlers configured to search and extract data from various internet-based data sources for storage in database 215, in which the extracted data may be processed by one or more modules of virtual environment analyzer module 220 and collaboration allocation module 240. Monitoring agents track interests from various external sources for which the user 270 has given access permission. Furthermore, one or more monitoring agents associated with server 210 may track social network relationships, activities, and the like associated with user 270 resulting in storage of applicable data within database 215. In particular, monitoring agents track and analyze the user's online activity, such as web searches, social media posts/interactions, online content consumption, including textual, audio, video content, AR/VR experiences, etc. Server 210 can categorize the user's actions into a predefined set of interest categories, and use of an interest and knowledge level ascertained from the tracking makes it possible to track temporal changes in interests of user 270 and ensures that interests are up to date and stored in database 215. In some embodiments, the tracking of interest and knowledge level allow server 210 to utilize the tracked actions to calculate and assign knowledge levels for various subject matters relevant to the virtual collaborations offered in a social network and/or a VR/AR system.

Virtual environment analyzer module 220 is configured to detect virtual environments and ascertain data associated with virtual environments including, but not limited to, contextual information, geographic data, spatial/temporal data associated with applicable users and data sources, and the like. In addition, virtual environment analyzer module 220 may detect dialogues, resources, and the like associated with the virtual environment for the purpose of determining whether the social media content attempting to be shared is subject to monitoring for sensitivity or privacy. The data that is processed and analyzed by virtual environment analyzer module 220 is configured to be stored in virtual environment analyzer module database 230, in which virtual environment analyzer module database 230 is designed to function as a repository continuously updated with not only data ascertained by analyses performed by virtual environment analyzer module 220, but also other applicable data sources including, but not limited to, crowdsourcing platforms, internet based data sources ascertained by web crawlers (e.g., social media platforms,), inputs of user 270 provided to the centralized platform, and the like. In some embodiments, contextual factors, parameters, and/or user preferences such as, for example, current weather conditions, a geographical location, physical features and styling, likes and dislikes, user's purchase and/or interest, and the like may be accounted for in virtual environment analyzer module database 230. As described herein, contextual information may include, but is not limited to, user location, topic/subject matter, date/time, environment/virtual object theme/setting, a participant threshold of user 270 associated with the virtual collaboration presented by the applicable social media network, participant dialogue concept, an event within the virtual environment (e.g., E-sport, dining experience, shopping experience, etc.), occurrences of a predetermined pattern of content or activity within the event, or any other applicable contextual-based data known to those of ordinary skill in the art. Virtual environment analyzer module 220 may further utilize one or more techniques to analyze virtual environments including, but not limited to, natural language processing (NLP), image analysis, topic identification, virtual object recognition, setting/environment classification, and any other applicable artificial intelligence and/or cognitive-based techniques known to those of ordinary skill in the art. Virtual environment analyzer module 220 is further tasked with providing techniques that facilitate automatic, reliable performance of a point cloud object-environment segmentation task in order to analyze virtual environments. For example, virtual environment analyzer 220 may provide the capability to perform automatic segmentation of a 3D point cloud into object and virtual environment segments by progressively learning the object-environment segmentation from tracking sessions in augmented reality (AR) applications associated with the centralized platform. In some embodiments, segmenting of the virtual environment allows virtual environment analyzer 220 to not only identify one or more virtual collaborations occurring within the virtual environment, but also ascertain various elements associated with virtual collaborations, such as, but not limited to, amount of users present, level of user engagement associated with a virtual collaboration, topics/subjects discussed in a virtual collaboration, and the like.

Collaboration allocation module 240 is configured to analyze virtual collaborations in order to determine if privatization and security is warranted for the integration of a presentation of social media content in the virtual environment. In some embodiments, collaboration allocation module 240 utilizes the segmenting performed by virtual environment analyzer 220 to perform partitioning of the detected virtual collaboration in order to assign the degree of shareability to one or more segments of the virtual collaboration derived from the partitioning. Partitioning of the virtual collaborations enables the degree of shareability to be allocated to the segments based upon one or more of the contextual information, current topic/subject being discussed in the virtual collaboration, user preferences, level of user engagement with particular virtual collaborations, and the like. For example, a segment of virtual collaboration may pertain to a sensitive subject matter in which the degree of shareability assigned to the applicable segment determines which users of the virtual collaboration have access to the particular virtual collaboration during the time period in which the sensitive subject matter is being discussed. Thus, certain users have access to the particular virtual collaboration at certain times of the discussion based upon the assigned degree of shareability of the segment which determines each users' access privileges during that segment.

In addition, collaboration allocation module 240 is further configured to analyze a user profile associated with user 270 in order to ascertain user data comprising, but not limited to, user personal data, user social media data, user activity data, user preferences, user inputs provided to the centralized platform, and the like for the purpose of optimizing the privacy and security of virtual collaborations associated with user 270 based on their history of interactions with social media content and their social media connections. For example, if user 270 is not connected (i.e., friends on the particular social network) with another user then either the virtual collaboration session and/or the social media content presented within the virtual reality is presented to the other user with limited accessing right assigned by collaboration allocation module 240 (e.g., other user only has viewing access to the virtual collaboration, cannot virtually vote or opine on a matter during dialogue, etc.).

In addition, collaboration allocation module 240 is tasked with detecting both users within the virtual collaboration and users attempting to gain access to the virtual collaboration via the applicable social network in order to classify said users as “participants” or “viewers”, in which a participant is assigned one or more capabilities to contribute to the virtual collaboration (e.g., screen sharing, vote casting, speaking rights, session recording, etc.) and a viewer may only view the virtual collaboration via the applicable social network. In addition, collaboration allocation module 240 is tasked with determining whether one or more components of a virtual environment and social media content shared by the applicable social media platform are shareable or un-shareable, in which shareability is a metric associated with who and what collaboration allocation module 240 is able to share with virtual collaboration viewers and participants. In some embodiments, classification of groups of users associated with social networks may be based on one or more of an engagement level, a virtual behavior pattern, and role associated with user 270.

It should be noted that in the acquiring, processing, utilizing, etc. of data by the proposed system, laws are observed, and privacy of user 270 is protected. In some embodiments, collaboration allocation module 240 is configured to protect the virtual environment or virtual collaboration by rendering content of the applicable social media network relative to the applicable user based on the contextual information, or privatizing one or more components of the rendered content based on shareability determined by collaboration allocation module 240. For example, live streamed content that has been deemed as sensitive or private may be rendered to user 270 from another user operating on the social network based upon collaboration allocation module 240 ascertaining the position (spatial information) of user 270 within the virtual environment. In addition, temporal information and shareability of virtual environments and social media content associated with the location of user 270 is factored into collaboration allocation module 240 determining to render the content for presentation to user 270.

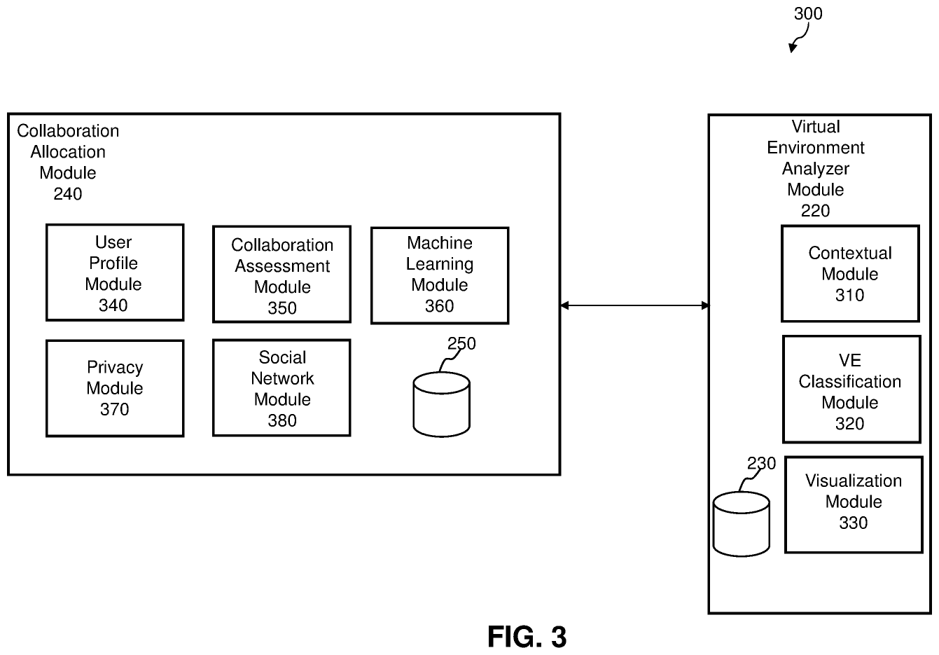

Referring now to FIG. 3, an example architecture 300 of virtual environment analyzer module 220 and collaboration allocation module 240 are depicted, according to an exemplary embodiment. In some embodiments, virtual environment analyzer module 220 comprises a contextual module 310, a virtual environment (VE) classification module 320, and a visualization module 330. Collaboration allocation module 240 comprises a user profile module 340, a collaboration assessment module 350, a machine learning module 360, a privacy module 370, and a social network module 380.

Contextual module 310 is designed to determine the context of a virtual environment, in which the context may be established by one or more of virtual environment elements (e.g., setting, theme, virtual objects, etc.), dialogue/topic/presenter associated with virtual collaboration, social media network provider, detected geographic location or virtual environment location of the user 270, and the like. For example, contextual module 310 may detect based on analysis of the virtual environment that user 270 is attending an E-sport event allowing contextual module 310 to determine that user 270 is a “public” setting where sensitive and/or private information associated with a virtual collaboration should not be transmitted or received. In another example, contextual module 310 may ascertain that subject matter of a virtual collaboration is sensitive based on applicable viewers and participants, or that user 270 is not engaged in the virtual collaboration due to a lack of activity within a virtual collaboration for a period of time, an utterance of one or more phrases indicating uncertainty/confusion, and the like. It should be noted that contextual module 310 may utilize cognitive/analytic systems, natural language processing (“NLP”), linear discriminant analysis (“LDA”), semantic analyzer, parsing functions, multi-media detection/analyses systems, computer visioning systems, and other applicable systems to ascertain contextual information of the virtual environment or dialogue/interactions viewers and participants associated with virtual collaborations.

VE classification module 320 is tasked with classifying the virtual environments based on one or more of activities occurring within the applicable virtual environment (e.g., dining, shopping, spectating, etc.), geographic location of user 270, virtual objects of the virtual environment (e.g., virtual agents, chatbots, interactive virtual elements, and the like), dialogue/topic/subject matter of virtual collaboration within the virtual environment, and any other applicable factor configured to assist with classifying a virtual environment known to those of ordinary skill in the art. In some embodiments, classification of virtual environments and elements thereof may be performed via segmenting of the virtual environment; however, various techniques may also be utilized including, but not limited to, image/video analysis, parsing, tokenizing, 3D point cloud segmentation, or any other applicable VR/AR-based analysis mechanism known to those of ordinary skill in the art. It should be known that one of the underlying purposes of VE classification module 320 classifying virtual environments is to assist collaboration allocation module 240 with determining whether a virtual collaboration is associated with private and/or sensitive subject matter. For example, VE classification module 320 may ascertain that an applicable virtual collaboration is a multi-player race track provided in a virtual environment, in which the virtual environment is a racing video game setting facilitated by an applicable gaming provider hosted by a social media-based platform. The physical environment surrounding user 270 would need to be analyzed and mapped in order for the gaming provider to augment the race track provided to computing device 260; thus, privacy concerns would arise in light of the virtual environment taking place in the physical environment being a private physical space of user 270 (e.g., living room, bedroom, etc.). Therefore, VE classification module 320 not only is configured to classify the virtual environment as a gaming space, but also VE classification module 320 is designed to classify the physical environment associated with user 270 as physical space where privacy concerns need to be addressed to sustain safe virtual collaborations.

Visualization module 330 is tasked with generating an AR-based visualization of virtual collaborations (e.g., a virtual reality model of the virtual collaboration or superimposing virtual content over a real-world view of the social media-based virtual collaboration in augmented reality) based on one or more analyses performed by collaboration allocation module 240. In particular, virtual collaborations are continuously analyzed by collaboration allocation module 240 in order to determine permission levels (hereinafter referred to as “access rights”), roles of users associated with the virtual collaborations (e.g., presenter, viewer, participant, etc.), and the like. AR/VR-based virtual collaborations and/or social media content provided therein may be modified by visualization module 330 based on the role assigned to user 270 by collaboration allocation module 240. For example, if collaboration allocation module 240 determines the role of user 270 within a virtual collaboration is a “participant”, then visualization module 330 modifies the virtual environment hosting the virtual collaboration and/or the social media content associated with the virtual collaboration in a manner that provides user 270 various functionalities such as, but not limited to, presentation integration, screen sharing, polling, or any other applicable host-based virtual collaboration features known those of ordinary skill of the art. In the instance in which collaboration allocation module 240 determines the role of user 270 as a “viewer”, then visualization module 330 modifies the virtual environment hosting the virtual collaboration and/or the social media content in a manner that provides user 270 only viewer functionality for the virtual collaboration. Visualization module 330 further supports rendering of the virtual environment in a manner in which user 270 may navigate the virtual environment while being engaged with the virtual collaboration. In some embodiments, user 270 provides an input indicating a desire to engage the virtual environment depicted on the social media network as a viewer or a participant via the centralized platform and/or within the virtual environment. User profile module 340 is configured to generate a user profile associated with user 270 and other applicable users in the virtual environments. The user profile is designed to indicate interests, current knowledge level regarding a topic of interest, social media activity, browsing patterns, user analytics, preferences, and the like associated with user 270, in which the user profile is stored on collaboration allocation module database 250. User profiles may further function as aggregations of user data associated with user 270 including, but not limited to, personal information, biological data, behavioral data, socio-demographic data, psychographic data, and the like continuously being updated via applicable data being received from one or more of server 210, computing device 260, and any other applicable data sources. The present invention may contain various accessible data sources, such as database 215, that may include personal and/or confidential company data, content, or information the user wishes not to be processed. Processing refers to any operation, automated or unautomated, or set of operations such as collecting, recording, organizing, structuring, storing, adapting, altering, retrieving, consulting, using, disclosing by transmission, dissemination, or otherwise making available, combining, restricting, erasing, or destroying personal and/or confidential company data. Server 210 enables the authorized and secure processing of personal data. Server 210 provides informed consent, with notice of the collection of personal and/or confidential company data, allowing the user to opt in or opt out of processing personal and/or confidential company data. Consent can take several forms. Opt-in consent can impose on the user to take an affirmative action before personal and/or confidential company data is processed. Alternatively, opt-out consent can impose on the user to take an affirmative action to prevent the processing of personal and/or confidential company data before personal and/or confidential company data is processed. System 200 provides information regarding personal and/or confidential company data and the nature (e.g., type, scope, purpose, duration, etc.) of the processing. Server 210 provides the user with copies of stored personal and/or confidential company data. Server 210 allows the correction or completion of incorrect or incomplete personal and/or confidential company data. Server 210 allows for the immediate deletion of personal and/or confidential company data.

In some embodiments, the user profile is configured to be analyzed and verified by privacy module 370, and privacy module 370 assigns the role to user 270 for a virtual collaboration based on the analysis and verification of the user profile. For example, the user profile might indicate that user 270 operates in a managerial capacity among participants in a virtual collaboration, in which privacy module 370 assigns the role of “host” to user 270 allowing user 270 to assign access rights to users to the virtual collaboration via the centralized platform, designate virtual collaboration functions to users, and the like. Upon verification and/or lack thereof by privacy module 370 to allow user 270 to attend the virtual collaboration, access rights to and/or shareability associated with the virtual collaboration are updated or re-assigned in accordance with the contextual information ascertained by contextual module 310, in which the virtual collaboration is terminated with proper closure for user 270 by privacy module 370 if user 270 currently has access to the virtual collaboration. Thus, reassignment of permission levels is based on the plurality of contextual information, in which the contextual information factors the participant threshold of the presentation within the virtual environment.

Collaboration assessment module 350 is tasked with analyzing virtual collaborations for the purpose of ascertaining virtual collaboration specific information. For example, collaboration assessment module 350 is designed to ascertain virtual collaboration contexts, virtual collaboration user thresholds, virtual collaboration operation bandwidths, number of participants/viewers associated with a virtual collaboration, user profiles of participants/viewers, and any other applicable virtual collaboration derived information known to those of ordinary skill in the art. For example, in the instance in which the virtual collaboration is a VR/AR based gaming experience, collaboration assessment module 350 is designed to analyze and determine the type of virtual collaboration taking place, the degree of shareability of the particular virtual collaboration, the number of participating gamers as opposed to viewers, the respective user profiles of the aforementioned, the gaming experience threshold and capacities, and the like. In some embodiments, collaboration assessment module 350 is configured to determine a degree of shareability associated with the virtual environment and/or the virtual collaboration within the virtual environment based on various factors including, but not limited to, contextual information received from contextual module 310, type of virtual collaboration, analyses performed on the user profiles, social network specific characteristics, threshold of the virtual environment hosting the virtual collaboration, etc. The degree of shareability is utilized as a component of one or more policies for the virtual collaboration generated by privacy module 370, in which the degree of shareability may be one of the factors that directly impacts the accessing rights and enabled functionalities of user 270. For example, if the contextual information results in the degree of shareability of a virtual collaboration being high, then user 270 may be enabled to perform screen sharing, commenting, polling, and the like within the virtual collaboration subject to classification provided in the policies by privacy module 370. The assigned degrees of shareability associated with virtual collaborations are configured to be stored, managed, and updated accordingly in collaboration allocation module database 250. Collaboration assessment module 350 is further configured to communicate with social network module 380 in order to classify a group of users associated with the virtual environment and/or virtual collaboration based on assessment of the social network connections of user 270 a particular social network. Classification of the users may not only assist with determining user affiliations, but also with determining the degree of shareability of a virtual environment and/or virtual collaborations. For example, social network module 380 accessing a social connections model allows collaboration assessment module 350 to ascertain that user 270 is not affiliated with a group of users on a social network resulting in the degree of shareability associated with the applicable virtual collaboration to be reduced (e.g., the group of users may not be able to view contributions of user 270 to the virtual collaboration).

Machine learning module 360 is configured to use one or more heuristics and/or machine learning models for performing one or more of the various aspects as described herein (including, in various embodiments, the natural language processing or image analysis discussed herein). In some embodiments, the machine learning models may be implemented using a wide variety of methods or combinations of methods, such as supervised learning, unsupervised learning, temporal difference learning, reinforcement learning and so forth. Some non-limiting examples of supervised learning which may be used with the present technology include AODE (averaged one-dependence estimators), artificial neural network, back propagation, Bayesian statistics, naive bays classifier, Bayesian network, Bayesian knowledge base, case-based reasoning, decision trees, inductive logic programming, Gaussian process regression, gene expression programming, group method of data handling (GMDH), learning automata, learning vector quantization, minimum message length (decision trees, decision graphs, etc.), lazy learning, instance-based learning, nearest neighbor algorithm, analogical modeling, probably approximately correct (PAC) learning, ripple down rules, a knowledge acquisition methodology, symbolic machine learning algorithms, sub symbolic machine learning algorithms, support vector machines, random forests, ensembles of classifiers, bootstrap aggregating (bagging), boosting (meta-algorithm), ordinal classification, regression analysis, information fuzzy networks (IFN), statistical classification, linear classifiers, fisher's linear discriminant, logistic regression, perceptron, support vector machines, quadratic classifiers, k-nearest neighbor, hidden Markov models and boosting, and any other applicable machine learning algorithms known to those of ordinary skill in the art. Some non-limiting examples of unsupervised learning which may be used with the present technology include artificial neural network, data clustering, expectation-maximization, self-organizing map, radial basis function network, vector quantization, generative topographic map, information bottleneck method, IBSEAD (distributed autonomous entity systems based interaction), association rule learning, apriori algorithm, eclat algorithm, FP-growth algorithm, hierarchical clustering, single-linkage clustering, conceptual clustering, partitional clustering, k-means algorithm, fuzzy clustering, and reinforcement learning. Some non-limiting examples of temporal difference learning may include Q-learning and learning automata. Specific details regarding any of the examples of supervised, unsupervised, temporal difference or other machine learning described in this paragraph are known and are considered to be within the scope of this disclosure. In particular, machine learning module 370 is configured to operate and maintain one or more machine learning models configured to utilize training datasets derived from database 215, virtual environment analyzer module database 230, collaboration allocation module database 250, and any other applicable data source, in which the one or more machine learning models are configured to generate outputs representing predictions of virtual environment contextual information, virtual collaboration accessing rights, social network used to host the virtual collaboration, social network based grouping of users for virtual collaborations, and the like.

Privacy module 370 is tasked with generating one or more policies associated with the virtual collaborations. It should be noted that the policies pertain to the role assigned to user 270, the level of access of user 270 to the virtual collaboration, the functionalities enabled for user 270 within the virtual collaboration, topic/subject matter classified as sensitive within applicable dialogue of the virtual collaboration, etc. One primary purpose of the policies is to allocate the role associated with the virtual collaboration to user 270, in which the role assignment may be based on one or more of the degree of shareability of the virtual environment and/or virtual collaboration, the contextual information, analyses of the user profiles, virtual collaboration-based functionalities available (e.g., screen-sharing, live commenting, etc.), and the like. In some embodiments, policies are managed on a blockchain or distributed ledger, in which privacy module 370 generates code interpretations and/or derivatives of the logic that determine which components of the virtual collaboration are protected and which are subject to view by user 270 or any other applicable user associated with the virtual collaboration. The blockchain further prevents undesired amendments to the policies allowing updates to the policies to be established by a trusted entity.

Social network module 380 is designed to manage and operate the social media content and social connections components associated with virtual collaborations. Connections established between server 210 and social network module 380 allow the centralized platform to function as a mechanism of user 270 to assign roles, permission levels, and functionalities to users associated with a virtual collaboration in the instance in which user 270 is the admin of a virtual collaboration. User 270 may also decide which social network platform they wish to share the virtual collaboration on via accessing the centralized platform, in which application programming interfaces (APIs) may function as plugins associated with the respective social network for the purpose of allowing social network module 380 to evaluate social connections, social media activity, and other applicable social network-based data associated with user 270. Social network module 380 also assists collaboration assessment module 350 with maintaining the number of users from a particular social network that may engage with the virtual collaboration in which the user threshold is assessed based on a level of user engagement/participation from the users of the social network. In some embodiments, privacy module 370 may factor this level of user engagement in the process of updating the policies resulting in the access rights being modified in real-time based on the contextual information associated with the virtual collaboration. Social network module 380 further assists with classifying groups of users associated with the virtual collaboration based on one or more of analyses of user profiles, skills of users, likes/preferences, demographics, and the like.

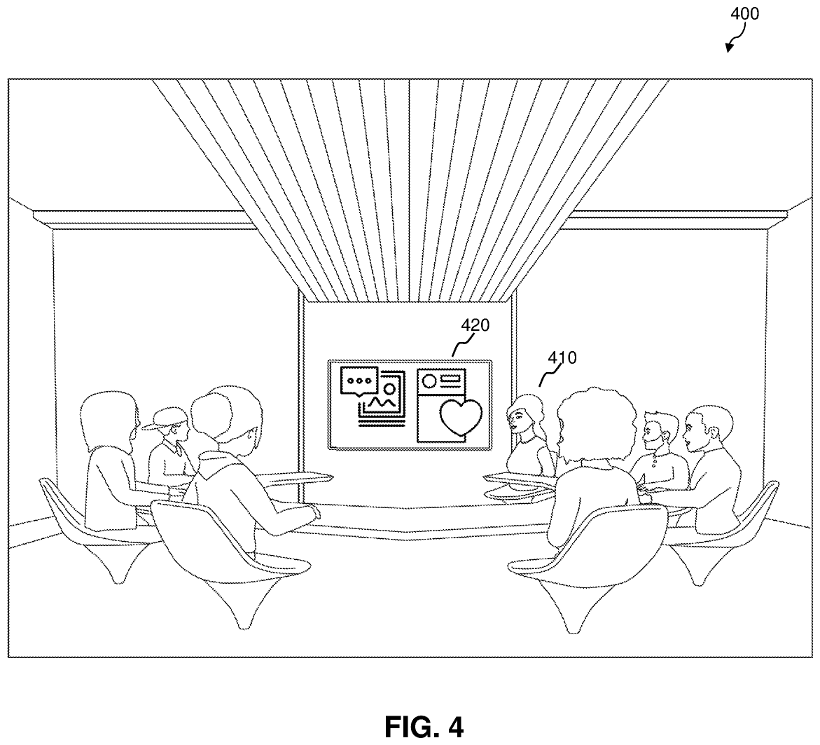

Referring now to FIG. 4, a virtual environment 400 associated with a social network is depicted, according to an exemplary embodiment. Virtual environment 400 hosts a virtual collaboration 410 in which a plurality of avatars may participate in virtual collaboration 410 by engaging with social media content 420, in which social media content 420 may include various types of multi-media in addition to an interactive hub. In some embodiments, the centralized platform provides the interactive hub in virtual environment 400 and visualization module 330 renders the interactive hub to display one or more of a total number of participants within the virtual environment hosted on the social media network, a role of each of the participants, and an option for an administrator to control the permission level allocated to each of the participants or user groups overall. For example, the interactive hub allows the avatars to view who has entered into the virtual collaboration and what their associated user's respective role is in virtual collaboration 410. The avatar with applicable access rights and role may control the user access rights of other users in virtual collaboration 410 directly by interacting with the interactive hub in virtual environment 400. Visualization of avatars may be privatized and/or reduced based on the role of the user associated with the respective avatar. For example, during a virtual collaboration only certain avatars may be visible to others within virtual environment 400 based on the respective users being connected on one or more social network platforms. In addition, in the instance virtual collaboration is a public livestream session, user 270 may join the virtual collaboration and designate whether to be a participant or viewer via the centralized platform.

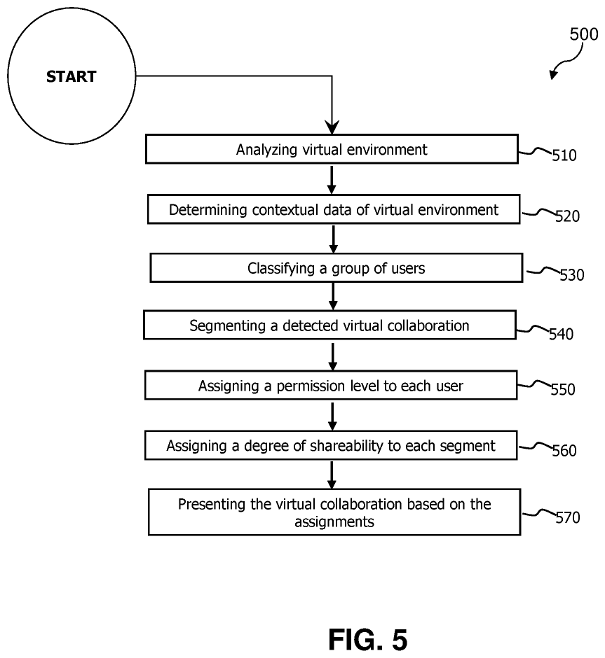

With the foregoing overview of the example architecture, it may be helpful now to consider a high-level discussion of an example process. FIG. 5 depicts a flowchart illustrating a computer-implemented process 500 for a method for sharing virtual environment collaboration, consistent with an illustrative embodiment. Process 500 is illustrated as a collection of blocks, in a logical flowchart, which represents a sequence of operations that can be implemented in hardware, software, or a combination thereof. In the context of software, the blocks represent computer-executable instructions that, when executed by one or more processors, perform the recited operations. Generally, computer-executable instructions may include routines, programs, objects, components, data structures, and the like that perform functions or implement abstract data types. In each process, the order in which the operations are described is not intended to be construed as a limitation, and any number of the described blocks can be combined in any order and/or performed in parallel to implement the process.

At step 510 of 500, virtual environment analyzer module 220 analyzes the applicable virtual environment. It should be noted that virtual environments, such as, but not limited to, metaverses, may require image/video analysis, parsing, tokenizing, 3D point cloud segmentation, or any other applicable VR/AR-based analysis mechanism known to those of ordinary skill in the art. Detected virtual collaborations within virtual environments, avatars, virtual objects/features, virtual environment layouts, and the like may support the analysis of the virtual environment performed by virtual environment analyzer module 220. In some embodiments, data associated with user 270 may be ascertained by computing device 260 via user interactions with the virtual environment and/or virtual collaborations. For example, analysis of targets associated with user gaze detection, topics of virtual collaborations highly engaged by user 270, frequently interacted with virtual objects, visual preferences, and the like are within the scope of this disclosure. Reinforcement learning may also be applied during the virtual environment analysis phase in order to optimize and fine-tune analyses based on previous analyses.

At step 520 of 500, contextual module 310 determines a plurality of contextual information of the virtual environment. Contextual module 310 determines the contextual information via utilizing various mechanisms such as, but not limited to, cognitive/analytic systems, NLP/linguistics analysis (e.g., word2vec, doc2vec, etc.), LDA, semantic analyzer, parsing functions, multi-media detection/analyses systems, computer visioning systems, applicable machine learning models operated by Machine learning module 360, etc. As previously mentioned, contextual information may include, but is not limited to, user location, topic/subject matter, date/time, environment/virtual object theme/setting, a participant threshold of user 270 associated with the virtual collaboration presented by the applicable social media network, participant dialogue concept, an event within the virtual environment (e.g., E-sport, dining experience, shopping experience, etc.), occurrences of a predetermined pattern of content or activity within the event, or any other applicable contextual-based data known to those of ordinary skill in the art.

At step 530 of 500, collaboration assessment module 350 classifies a group of users associated with the virtual environment and/or virtual collaboration. In some embodiments, the classification of users in the group is based on one or more of contextual information, social connections among users in the group associated with social network platforms, assigned degree of shareability associated with one or more virtual collaborations (including segments of virtual collaborations) of the virtual environment, and the like. One important purpose of classifying the users of a group is for applicable permission levels to be assigned to users accordingly. As a result, certain users may have access to a segment of a virtual collaboration that other users of the group do not because of various factors such as the social network connection, current subject of the virtual collaboration, contextual information, and the like.

At step 540 of 500, virtual environment analyzer module 220 performs segmenting of a detect virtual collaboration associated with the virtual environment. One important purpose of segmenting virtual collaborations is to allow partitioning of virtual collaborations so that a degree of shareability can be assigned to the resulting segments of the virtual collaborations. As a result, user 270 may have access to a segment of a virtual collaboration that other users do not; thus, providing an enhanced layer of privacy to not only the virtual environment, but also each virtual collaboration occurring within the virtual environment.

At step 550 of 500, privacy module 370 assigns a permission level to each user of the group. In some embodiments, the assignment of a permission level to a user is based upon one or more of the classification of the user group, contextual information, the media content shared within the virtual collaboration, social network connections among users of the group, degree of shareability assigned to the virtual environment and/or virtual environment, etc. Permission levels may further indicate the functionalities available to users within the virtual collaboration, in which users may have a role which may be an admin, a viewer, or a participant. For example, a viewer may only have permission to view a virtual collaboration and may not have functionalities to record virtual collaborations, vote, speak, contribute media content, screen-share, and the like. However, permission level for a user may be modified based upon contextual information or a detected change in the dynamic of the virtual collaboration or users within the virtual environment.

At step 560 of 500, privacy module 370 assigns a degree of shareability to each segment of the virtual collaboration. Assignment of the degree of shareability may be based on the contextual information, analyses of the user profiles, current topic being discussed in the segment, presenter of content in the segment (e.g., sensitive party requiring privileged access right to participants/viewers), modifications to users in the associated virtual environment, and the like. Due to the inherent fluctuation of users in virtual environments associated with social network platforms it is imperative for the degree of shareability for virtual environments and virtual collaborations to be able to be modified in real-time. In some embodiments, user 270 may determine the degree of shareability by accessing the centralized platform via computing device 260.

At step 570 of 500, social network module 380 presents the virtual collaboration based on the assignments of privacy module 370. In some embodiments, privacy module 370 determines who to present the virtual collaboration to based on the analyses of the user profiles associated with users participating in the virtual collaboration. It should be noted that both the assignment of the permission levels and the degree of shareability dictates not only who has access to virtual environments and/or virtual collaborations, but also what functionalities users have within the aforementioned. In some embodiments, user 270 may select the assigned roles to users in a virtual collaboration via the centralized platform, in which this feature may be visualized to user 270 within the virtual environment allowing the associated avatar to choose roles for users in the virtual collaboration in a privatized manner. In the instance in which user 270 is the administrator, they may also perform re-grouping of the users and/or assign group specific permission levels in order to ease the process of assigning access rights to virtual environments and/or virtual collaborations.

Based on the foregoing, a method, system, and computer program product have been disclosed. However, numerous modifications and substitutions can be made without deviating from the scope of the present invention. Therefore, the present invention has been disclosed by way of example and not limitation.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises,” “comprising,” “includes,” “including,” “has,” “have,” “having,” “with,” and the like, when used in this specification, specify the presence of stated features, integers, steps, operations, elements, and/or components, but does not preclude the presence or addition of one or more other features, integers, steps, operations, elements, components, and/or groups thereof.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-payment devices or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g. light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter payment device or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The descriptions of the various embodiments of the present invention have been presented for purposes of illustration but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

It will be appreciated that, although specific embodiments have been described herein for purposes of illustration, various modifications may be made without departing from the spirit and scope of the embodiments. In particular, transfer learning operations may be carried out by different computing platforms or across multiple devices. Furthermore, the data storage and/or corpus may be localized, remote, or spread across multiple systems. Accordingly, the scope of protection of the embodiments is limited only by the following claims and their equivalent.

What is claimed is:

1. A computer-implemented method for sharing virtual environment collaboration, the method comprising:
analyzing, by a computing device, a virtual environment;
determining, by the computing device, a plurality of contextual information and a degree of shareability associated with the virtual environment based on the analysis; and
presenting, by the computing device, the virtual environment to a social media network associated with a user based on the degree of shareability.

2. The computer-implemented method of claim 1, wherein determining the degree of shareability comprises:
segmenting, by the computing device, the virtual environment; and
classifying, by the computing device, a group of users associated with the social media network for access to the virtual environment.

3. The computer-implemented method of claim 2, wherein segmenting the virtual environment comprises:
identifying, by the computing device, a virtual collaboration associated with the virtual environment;
partitioning, by the computing device, the virtual collaboration; and
assigning, by the computing device, the degree of shareability to at least one partition of the virtual collaboration based on the plurality of contextual information.

4. The computer-implemented method of claim 2, wherein presenting the virtual environment comprises:
assigning, by the computing device, a permission level to each user of the group based on the classification of the group of users;
wherein the classification accounts for one or more of a user participation level, a user virtual behavior pattern, and a user role.

5. The computer-implemented method of claim 1, wherein presenting the virtual environment comprises:
receiving, by the computing device, an input from the user indicating a desire to engage the virtual environment depicted on the social media network as a viewer or a participant.

6. The computer-implemented method of claim 4, further comprising:
reassigning, by the computing device, the permission level based on the plurality of contextual information;
wherein the contextual information comprises at least a participant threshold associated with the presentation of the virtual environment on the social media network.

7. The computer-implemented method of claim 1, wherein presenting the virtual environment further comprises:
displaying, by the computing device, a total number of participants within the virtual environment hosted on the social media network, a role of each of the participants, and an option for an administrator to control the permission level allocated to each of the participants.

8. A computer program product for sharing virtual environment collaboration, the computer program product comprising or more computer readable storage media and program instructions collectively stored on the one or more computer readable storage media, the stored program instructions comprising:
program instructions to analyze a virtual environment;
program instructions to determine a plurality of contextual information and a degree of shareability associated with the virtual environment based on the analysis; and
program instructions to present the virtual environment to a social media network associated with a user based on the degree of shareability.

9. The computer program product of claim 8, wherein the program instructions to determine the degree of shareability comprise:
program instructions to segment the virtual environment; and
program instructions to classify a group of users associated with the social media network for access to the virtual environment.

10. The computer program product of claim 9, wherein the program instructions to segment the virtual environment comprise:
program instructions to identify a virtual collaboration associated with the virtual environment;
program instructions to partition the virtual collaboration; and
program instructions to assign the degree of shareability to at least one partition of the virtual collaboration based on the plurality of contextual information.

11. The computer program product of claim 9, wherein program instructions to present the virtual environment comprise:
program instructions to assign a permission level to each user of the group based on the classification of the group of users;
wherein the classification accounts for one or more of a user participation level, a user virtual behavior pattern, and a user role.

12. The computer program product of claim 8, wherein program instructions to present the virtual environment comprise:
program instructions to receive an input from the user indicating a desire to engage the virtual environment depicted on the social media network as a viewer or a participant.

13. The computer program product of claim 11, further comprising:
program instructions to reassign the permission level based on the plurality of contextual information;
wherein the contextual information comprises at least a participant threshold associated with the presentation of the virtual environment on the social media network.

14. The computer program product of claim 8, wherein program instructions to present the virtual environment comprise:
program instructions to display a total number of participants within the virtual environment hosted on the social media network, a role of each of the participants, and an option for an administrator to control the permission level allocated to each of the participants.

15. A computer system for sharing virtual environment collaboration, the computer system comprising:
one or more processors;
one or more computer-readable memories;
program instructions stored on at least one of the one or more computer-readable memories for execution by at least one of the one or more processors, the program instructions comprising:
program instructions to analyze a virtual environment;
program instructions to determine a plurality of contextual information and a degree of shareability associated with the virtual environment based on the analysis; and
program instructions to present the virtual environment to a social media network associated with a user based on the degree of shareability.

16. The computer system of claim 15, wherein the program instructions to determine the degree of shareability comprise:
program instructions to segment the virtual environment; and
program instructions to classify a group of users associated with the social media network for access to the virtual environment.

17. The computer system of claim 15, wherein the program instructions to determine the degree of shareability comprise:
program instructions to segment the virtual environment; and
program instructions to classify a group of users associated with the social media network for access to the virtual environment.

18. The computer system of claim 16, wherein the program instructions to segment the virtual environment comprise:
program instructions to identify a virtual collaboration associated with the virtual environment;
program instructions to partition the virtual collaboration; and
program instructions to assign the degree of shareability to at least one partition of the virtual collaboration based on the plurality of contextual information.

19. The computer system of claim 16, wherein program instructions to present the virtual environment comprise:
program instructions to assign a permission level to each user of the group based on the classification of the group of users;
wherein the classification accounts for one or more of a user participation level, a user virtual behavior pattern, and a user role.

20. The computer system of claim 19, further comprising:
program instructions to reassign the permission level based on the plurality of contextual information;
wherein the contextual information comprises at least a participant threshold associated with the presentation of the virtual environment on the social media network.
